(19) United States
(12) Patent Application Publication
(10) Pub. No.: US 2019/0108482 A1
(43) Pub. Date: Apr. 11, 2019

(54) ENABLEMENT OF PROCUREMENT PROCESSES WITH ASSET TRACEABILITY USING BLOCKCHAIN TECHNOLOGY

(71) Applicant: SAP SE, Walldorf (DE)

(72) Inventors: Kumar Vikas, Bangalore (IN); Rajesh Chinnakonda, Bangalore (IN)

(21) Appl. No.: 15/726,693

(22) Filed: Oct. 6, 2017

(51) Int. Cl. G06Q 10/08; G06Q 30/06

(52) U.S. Cl. CPC G06Q 10/0838; G06Q 30/0635

(57) ABSTRACT

A method of using blockchain technology to verify data items pertaining to a specimen of wild flora or fauna is disclosed. A blockchain is distributed across a plurality of machines and associated with a transaction pertaining to the specimen. A first group of the plurality of machines executes seller-side blockchain operations, including writing data items pertaining to origin and transfers of ownership of the specimen in a block of a plurality of blocks of the blockchain. A second group of the plurality of machines executes one or more buyer-side blockchain operations, including writing data items pertaining to additional transfers of ownership as one or more additional blocks of the plurality of blocks of the blockchain. A third group of the plurality of machines executes one or more verification applications to access one or more of the plurality of blocks of the blockchain to verify the one or more data items.

### TECHNICAL FIELD

The present disclosure generally relates to blockchain technology (also known as “distributed ledger technology”) and, in one specific example, to applying blockchain technology to tracking and tracing goods in procurement and supply chains.

### BACKGROUND

A blockchain is a reliable record of who owns what, and who transacts what. Blockchain technology is based on distributed ledger technology, which records data (transactions, files, or information) across a peer-to-peer network. Every participant can see the data and verify (or reject) it using consensus algorithms. Approved data is entered into the ledger as a collection of “blocks,” stored in a chronological “chain,” and secured through cryptography.

Although it was originally created as the underlying technology for trading the digital currency Bitcoin, blockchain technology's potential reaches far beyond crvptocurrency. Blockchains can include land titles, loans, intellectual property, identities, votes—almost anything of value.

### BRIEF DESCRIPTION OF THE DRAWINGS

FIG. 1 is a block diagram depicting an example blockchain system 100.

FIG. 2 is a block diagram illustrating an example relationship between the parties to a transaction involving a good that is regulated under an international treaty and an updating of a blockchain pertaining to the transaction.

FIG. 3 is a block diagram depicting example data items included in Block A and Block B of FIG. 2.

FIG. 4 is a flowchart depicting example operations performed by one or more machines associated with a supplier of raw materials.

FIG. 5. is a flowchart depicting example operations pertaining to a raw procurement process according to some example embodiments.

FIG. 6 is a flowchart depicting example operations performed by one or more machines associated with a third party (e.g., a carrier agent) involved in a transaction of the specimen of FIG. 4.

FIG. 7 is a flowchart depicting example operations performed by one or more machines associated with a purchaser of the specimen of FIG. 4.

FIG. 8A and FIG. 8B are a flowchart depicting example operations pertaining to production of a finished product from raw materials according to some example embodiments.

FIG. 9 is a block diagram of a machine in the example form of a computer system within which instructions for causing the machine to perform any one or more of the operations or methodologies discussed herein may be executed.

### DETAILED DESCRIPTION

In the following description, for purposes of explanation, numerous specific details are set forth in order to provide an understanding of example embodiments of the present subject matter. It will be evident, however, to those skilled in the art that example embodiments may be practiced without these specific details.

By establishing an added level of trust and security to traditional models, blockchain technology gives participants the opportunity to transact more directly with each other, reducing the need for some types of intermediaries, like banks. The result is streamlined, more transparent payments and contracting processes.

Since transactions (blocks) are chronologically linked, they cannot be altered without breaking the entire chain of transactions in a network. This chain is replicated and synchronized on every computer that uses the network (instead of being centrally stored)—which creates an immutable system of record, built-in transparency, and trust among participants.

A distributed ledger replicates and distributes data (transactions, files, or information) across multiple sites, countries, or institutions—without centralized administration or control.

This technology allows each party in the network to access and own an identical copy of the record—and any changes or additions are propagated and reflected on all copies. Because the record has witnesses and isn't centrally stored, security breaches are more difficult. One example of digital ledger technology in action is blockchain.

Blockchains are inherently digital, and therefore programmable—so participants can set up rules to automatically trigger actions, events, and payments once conditions are met. This will pave the way for smart contracts: self-executing agreements made by multiple parties.

For example, smart contracts have the potential to use real-world information from GPS, RFID, or IoT devices to trigger supply chain workflows, events, or actions—such as payments or asset transfers.

There are four main ways to establish blockchain systems: public, consortium, semi-private, and private.

Consortium blockchains and semi-private blockchains (aka “permissioned blockchains”) have the most promise for the majority of enterprises. Because the consensus process is carried out by trusted actors, maintaining a shared ledger is simpler and faster—and businesses can maintain privacy.

Public blockchains: Anyone can read a public blockchain, send transactions to it, or participate in the consensus process. Every single transaction is public, and users can remain anonymous. Bitcoin is an example of a public blockchain.

Consortium blockchains: In a consortium blockchain, the consensus process is controlled by a pre-selected group—a group of financial institutions, for example. The right to read the blockchain and submit transactions to it may be public or restricted to participants.

Semi-private blockchains: Semi-private blockchains are run by a single company that grants access to any user who satisfies pre-established criteria. There are no discriminatory barriers to access, and in some cases these blockchains can be completely open. Semi-private blockchains are suited for business to business (B2B) use cases as well as government applications.

Private blockchains: Fully private blockchains are controlled by a single organization. The organization determines who can read it, submit transactions to it, and participate in the consensus process. However, these private ledgers are missing a key blockchain ingredient: decentralization. As a result, they are better suited to organizations exploring blockchain implementation (i.e. for use as a sandbox or testing environment), but not for actual production.

Blockchain as a service (BaaS) lets companies access distributed ledger technology in the cloud. Here are some of the expected benefits of BaaS:

Fewer Intermediaries. Blockchain is a true peer-to-peer platform that will reduce the need for some types of third-party intermediaries like banks, lawyers, and brokers.

Faster Processes. Blockchain can speed up process execution in multi-party scenarios—and allow for faster transactions that aren't limited by office hours.

Transparency. Information in blockchains is viewable by all participants and cannot be altered. This will reduce risk and fraud, and create trust.

Return on Investment (ROI). Distributed ledgers will provide quick ROI by helping businesses create leaner, more efficient, and more profitable processes.

Security. The distributed and encrypted nature of blockchain mean it will be difficult to hack. This shows promise for business and IoT security.

Automation. Blockchain is programmable—which will make it possible to automatically trigger actions, events, and payments once conditions are met.

With BaaS, developers can build blockchain extensions for existing applications across industries and lines of business, integrate distributed ledger features in the blockchain ecosystems to create synergies, especially in multi-party processes, and use blockchain in combination with other advanced technologies, including Internet of Things (IoT), analytics, Big Data, and data intelligence technologies. For example, any Internet of Things (IoT) device can register an event that automatically triggers a business process, such as ordering new inventory to keep a production line running. Here the blockchain, as a trusted distributed ledger, can help ensure validation of the order through a digital signature and facilitate the order getting through to the company's network of suppliers. In a more complex digital supply chain scenario, different suppliers might be able to submit their offers directly to blockchain, and the actual order is anchored in the distributed ledger as well. New suppliers only need to be onboarded onto the blockchain network once, and can then subsequently benefit from the built-in trust when interacting with other participants.

Blockchain technology can be used to improve transparency and accountability across the supply chain. For example, applications can be used to track and trace materials back to the source, prove authenticity and origin, get ahead of recalls, and accelerate the flow of goods.

An issue that some companies face is tracking and tracing goods before, during, and after shipment. It is possible that a seller will ship something to a warehouse where it is swapped for a knock off without the buyer knowing. Because the distributed ledger capability of blockchain provides buyers and sellers with increased visibility and control from shipment to receive, the risk of such fraud may be reduced.

The distributed ledger capability may securely capture one or more defining characteristics of valuable objects, such as diamonds or any of the other objects described herein, and create a digital thumbprint of the asset that is stored on the blockchain. This information, including history, transport, events and ownership, is relied upon by multiple stakeholders across global supply chains to verify authenticity.

By harnessing blockchain technology into procurement applications and procurement networks (e.g., SAP Ariba), a global platform of provenance can be built, connecting records of authenticity to a physical object and its certification as it moves throughout the supply chain.

The Convention on International Trade in Endangered Species of Wild Fauna and Flora (CITES) works by subjecting international trade in specimens of selected species (e.g., of 5,600 species of animals and 30,000 species of plants that are protected under the Convention as of 2017) to certain controls. All import, export, re-export and introduction from the sea of species covered by the Convention are authorized through a licensing system. Each Party to the Convention designates one or more Management Authorities in charge of administering that licensing system and one or more Scientific Authorities to advise them on the effects of trade on the status of the species.

The specifies covered by CITES are listed in three Appendices, according to the degree of protection they need.

Appendix I includes species threatened with extinction. Trade in specimens of these species is permitted only in exceptional circumstances.

Appendix II includes species not necessarily threatened with extinction, but in which trade must be controlled in order to avoid utilization incompatible with their survival. The Conference of the Parties (CoP), which is the supreme decision-making body of the Convention and comprises all its Parties, has agreed on a set of biological and trade criteria to help determine whether a species should be included in Appendices I or II.

Appendix III contains species that are protected in at least one country, which has asked other CITES Parties for assistance in controlling the trade. Changes to Appendix III follow a distinct procedure from changes to Appendices I and II, as each Party) is entitled to make unilateral amendments to it.

A specimen of a CITES-listed species may be imported into or exported (or re-exported) from a State party to the Convention only if the appropriate document has been obtained and presented for clearance at the port of entry or exit. There is some variation of the requirements from one country to another and it may be necessary to check on the national laws that may be stricter, but the basic conditions that apply are described below.

Appendix-I Specimens

First, for Appendix-I specimens, an import permit issued by the Management Authority of the State of import is required. This may be issued only if the specimen is not to be used for primarily commercial purposes and if the import will be for purposes that are not detrimental to the survival of the species. In the case of a live animal or plant, the Scientific Authority must be satisfied that the proposed recipient is suitably equipped to house and care for it.

Second, for Appendix-I specimens, an export permit or re-export certificate issued by the Management Authority of the State of export or re-export is also required. An export permit may be issued only if the specimen was legally obtained; the trade will not be detrimental to the survival of the species; and an import permit has already been issued. A re-export certificate may be issued only if the specimen was imported in accordance with the provisions of the Convention and, in the case of a live animal or plant, if an import permit has been issued. In the case of a live animal or plant, it must be prepared and shipped to minimize any risk of injury, damage to health or cruel treatment.

Appendix-II Specimens

First, for Appendix-II specimens, an export permit or re-export certificate issued by the Management Authority of the State of export or re-export is required. An export permit may be issued only if the specimen was legally obtained and if the export will not be detrimental to the survival of the species. A re-export certificate may be issued only if the specimen was imported in accordance with the Convention.

Second, for Appendix-II specimens, in the case of a live animal or plant, it must be prepared and shipped to minimize any risk of injury, damage to health or cruel treatment.

Third, for Appendix-II specimens, no import permit is needed unless required by national law. In the case of specimens introduced from the sea, a certificate has to be issued by the Management Authority of the State into which the specimens are being brought, for species listed in Appendix I or II.

Appendix-III Specimens

First, for Appendix-III specimens, in the case of trade from a State that included the species in Appendix III, an export permit issued by the Management Authority of that State is required. This may be issued only if the specimen was legally obtained and, in the case of a live animal or plant, if it will be prepared and shipped to minimize any risk of injury, damage to health or cruel treatment.

Second, for Appendix-III specimens, in the case of export from any other State, a certificate of origin issued by its Management Authority is required.

Third, for Appendix-Ill specimens, in the case of re-export, a re-export certificate issued by the State of re-export is required.

Exceptions

The Convention allows or requires Parties to make certain exceptions to the general principles described above, notably in the following cases: for specimens in transit or being shipped, for specimens that were acquired before CITES provisions applied to them, for specimens that are personal or household effects, for animals that were ‘bred in captivity,’ for plants that were ‘artificially propagated,’ for specimens that are destined for scientific research, for animals or plants forming part of a travelling collection or exhibition, such as circus. When a specimen of a CITES-listed species is transferred between a country that is a Party to CITES and a country that is not, the country that is a Party may accept documentation equivalent to the permits and certificates described above.

Therefore, parties transacting in goods that make use of endangered species of wild flora and fauna, such as those protected by CITES, may need to produce appropriate documents when the goods cross international borders. Plants and animals of endangered species may have to be transported alive or their parts may have to be transported as raw material (e.g., to a manufacturing facility). Also, after finished goods are made, the goods may have to be transferred to a customer along with the appropriate documentation.

Blockchain technology can be used to record this documentation. For example, due to its tamper proof and non-repudiable nature of record, blockchains can be used to create and maintain import permits, export or re-export certificates as well as certificates of origins. Then such permits and certificates need not be carried physically by carrier agents along the supply chain, or by the customer, when the finished goods move across international borders.

In example embodiments, a blockchain ledger entry for the respective permits or licenses or certificates can record date/time stamps, period of validity, or ownership details. Furthermore, all the involved controlling parties, such as government authorities, like customs departments, that verify the validity of the permits and certificates. CITES secretariats that generate permits and licenses, or local or global CITES Management authorities that verify or hold the permits or certificates, can refer to the blockchain with an electronic verification system, since the blockchain is a tamper proof and non-repudiable system.

In example embodiments, a method of using blockchain technology to verify an authenticity of a specimen of wild flora or fauna is disclosed. A blockchain is distributed across a plurality of machines and associated with a transaction pertaining to the specimen. A first group of the plurality of machines executes seller-side blockchain operations, including writing data items pertaining to a certificate of origin of the specimen in a block of a plurality of blocks of the blockchain. A second group of the plurality of machines executes one or more buyer-side blockchain operations, including writing data items pertaining to transfer of ownership in additional blocks of the plurality of blocks of the blockchain, a third group of the plurality of machines executes one or more verification applications to access one or more of the plurality of blocks of the blockchain to verify authenticity of the specimen at various stages of the transaction.

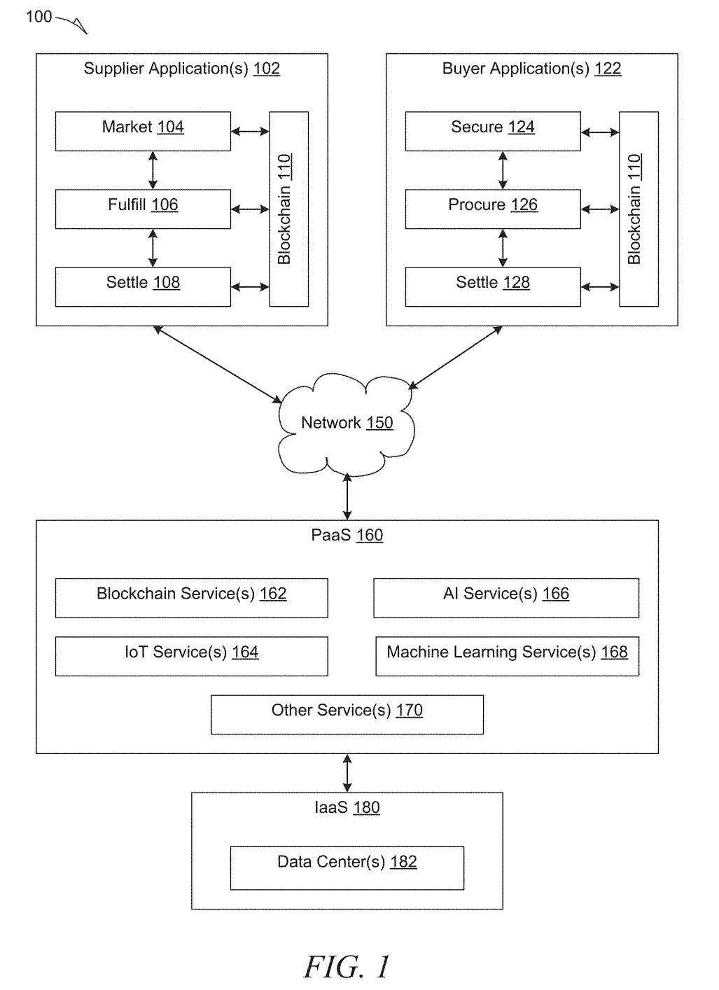

FIG. 1 is a block diagram depicting an example blockchain system 100. The example blockchain system 100 includes software-as-a-service (SaaS) applications, including supplier application(s) 102 and buyer application(s) 122. The example blockchain system 100 also includes platform-as-a-service (PaaS) 160, which is coupled via a network 150 (e.g., the Internet, a Wide Area Network (WAN), a Local Area Network (LAN), or digital marketplace (e.g., SAP Ariba Network) to various PaaS services. In example embodiments, the PaaS 160 is a cloud platform that is supported by infrastructure-as-a-service (IaaS) 180, which, in turn, provides cloud-based resources, including hardware, computing power, and storage space, to the PaaS platform (e.g., from data center(s) 182).

In example embodiments, the supplier application(s) 102 may include software applications for handling supplier-side operations, including market 104, fulfill 106, and settle 106 operations, each of which is connected to the blockchain 110. Additionally, the buyer application(s) may include software applications for handling buyer-side operations, including secure 124, procure 126, and settle 128 operations, each of which is connected to the blockchain 110.

The PaaS 160 may include platform services, including blockchain service(s) 162. Internet-of-Things (IoT) services 164, artificial intelligence (AI) service(s) 166, and machine-learning service(s) 168. Other examples of platform services may include user experience, mobile, integration, collaboration, security, or analytics services. The PaaS 160 may also include other service(s) 170, such as business services (e.g., commerce, loyalty, or customer-engagement services) and data and storage services (e.g., database services, such as in-memory database services). The PaaS 160 may also include runtimes (e.g., Java. HTML5, NodeJS, Hana XS runtimes) or development and IT operations (DevOps) services to allow developers to develop and manage applications, including debugging, life cycle management, and performance statistics services.

The database system may include an index server component that contains data and engines for processing the data. The database system may also include a name server component that owns information about the topology of the database system and, in a distributed system with instances of the database system on multiple hosts, knows where components are running and which data is on which server. The database system may also include an extended application services (XS) (e.g., SAP Hana XS) component for running database system applications without the need to run an additional application server. The XS component may include an XS classic server that, for example, executes applications written by developers as well as web-based tools, such as lifecycle management and development tools, and an advanced runtime server. The XS component may also include an XS Advanced Runtime component that, for example, includes an additional run-time environment for executing advanced application and platform services.

The database system may include an extended store server for providing high-performance disk-based column store for very big data (e.g., in the petabyte range), a data provisioning server that provides capabilities such as data provisioning in real time and batch mode, real-time data transformations, data quality functions, adapters for various types of remote sources, and an adapter SDK for developing additional adapters, a streaming cluster component that provides an event stream processor for consuming data streams and complex event processing, and a deployment infrastructure server that handles deployment of design-time artifacts into the database system.

The database system may also include a preprocessor server component that may be used by the index server to analyze text data and extract information on which text search capabilities are based, a compile server component that performs compilation of stored procedures and programs, such as SQLScript procedures: a script server component that is used to execute application function library written in various computer languages (e.g., C++): a web dispatcher component that processes inbound HTTP and HTTPS connections to XS services, and a start service component that is responsible for starting and stopping the other services in the correct order and monitors their runtime state.

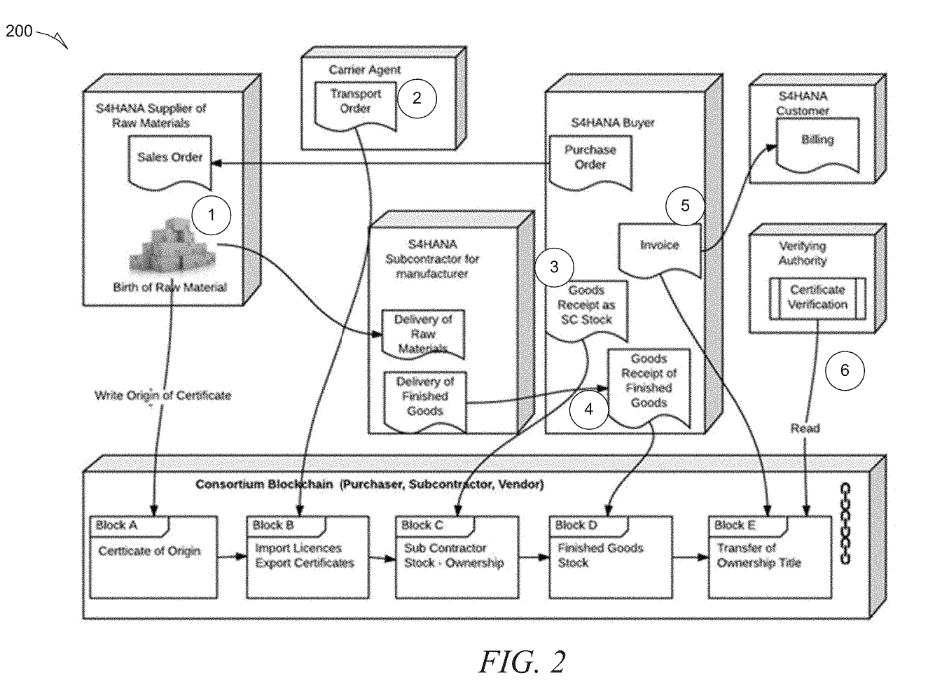

FIG. 2 is a block diagram illustrating an example relationship between the parties to a transaction pertaining to CITES goods and an updating of a blockchain pertaining to the transaction.

At operation 1, discovery or sourcing of a raw material takes place. For example, raw materials, such as diamonds or other minerals are mined, animal products are source from ranches, and so on. When the raw material is obtained, a certificate of origin is written to a consortium blockchain (e.g., as “Block A”).

At operation 2, a purchaser submits a purchase order for the raw material from the supplier of the raw material (e.g., via the SaaS applications of FIG. 1, such as SAP Ariba or SAP S4HANA applications). When a raw material (or a good including the raw material) is transferred (e.g., via a subcontractor, such as a carrier agent, and pursuant to a transport order) across international borders, any required documentation (e.g., export permits and import permits) are obtained and recorded in the blockchain (e.g., as “Block B”). For example, the supplier application(s) 102 call one or more APIs of the blockchain service(s) 162 to write the documentation to the block chain. This documentation can then be verified on the blockchain by any authorized verifying authority.

At operation 3, if and when the purchaser is informed of a raw material transfer to a subcontractor, the purchaser moves the stock to subcontractor stock and, simultaneously, subcontractor stock ownership (e.g., “goods receipt as SC stock”) is recorded in the blockchain (e.g., as “Block C”). For example, one or more SaaS applications executing on one or more machines of the subcontractor calls one or more APIs of the blockchain service(s) 162 to write documentation pertaining to subcontractor stock ownership to the blockchain.

At operation 4, when finished goods are delivered to the purchaser, the stock is updated and a corresponding entry (e.g., a “goods receipt of finished goods”) is written to the block to record receive of the finished goods (e.g., as “Block D”). For example, one or more SaaS applications executing on one or more machines of the purchaser calls one or more APIs of the blockchain service(s) 162 to write documentation pertaining to the finished goods stock to the blockchain.

At operation 5, when finished goods are sold to a customer, the ownership transfer (e.g., an “invoice” corresponding to “transfer of ownership title”) is recorded in the blockchain (e.g., as “Block E”). For example, one or more SaaS applications executing on one or more machines of the purchaser or customer calls one or more APIs of the blockchain service(s) 162 to write documentation pertaining to the ownership transfer to the blockchain.

At operation 6, a verifying authority, such as customs department of an importing country, can verify any documentation recorded in the blockchain, including certificate of origin, export and import certificates, and ownership titles. For example, one or more SaaS applications executing on one or more machines of the verifying authority calls one or more APIs of the blockchain service(s) 162 to access the appropriate documentation.

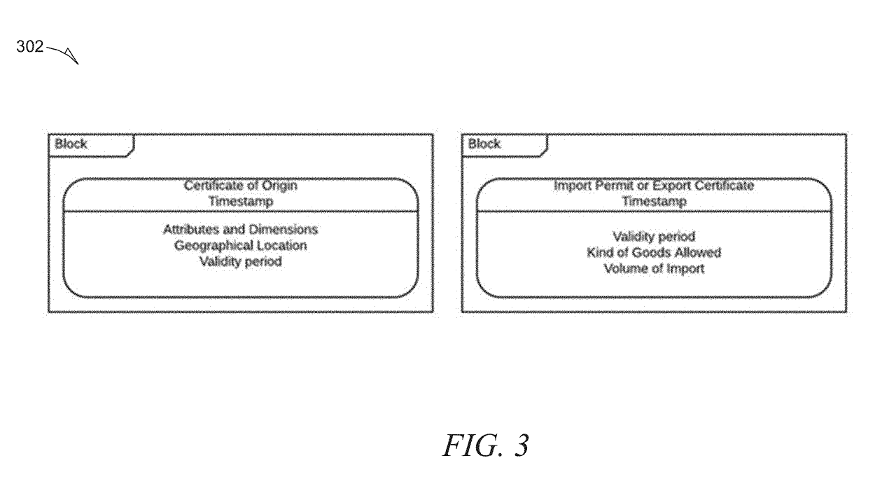

FIG. 3 is a block diagram depicting example data items included in Block A and Block B of FIG. 2. As depicted, Block A includes various data items pertaining to a certificate of origin, including certificate of origin time stamp, attributes and dimensions, geographical location, and validity period data items. Block B includes various data items pertaining to an import permit or export certificate, including import permit or export certificate time stamp, a validity period, kinds of goods allowed, and volume of import data items.

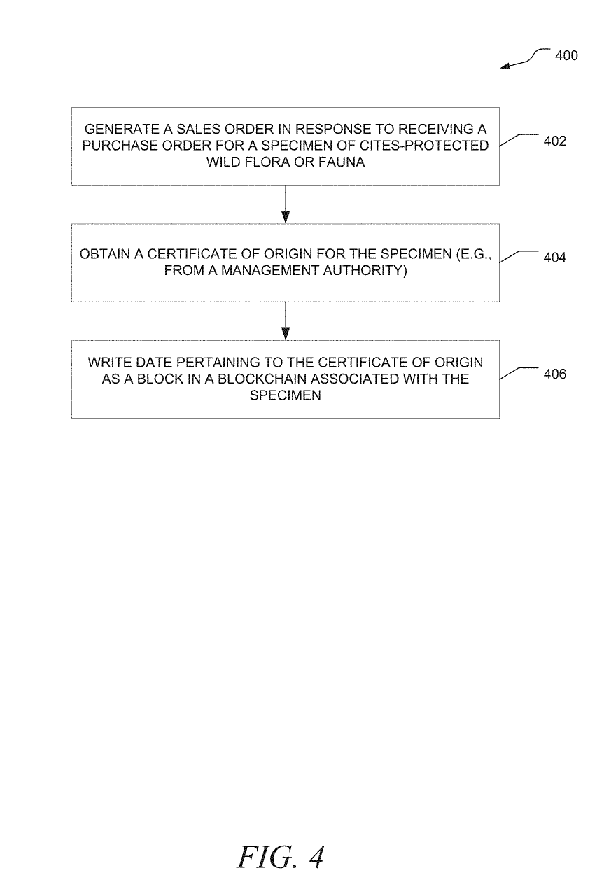

FIG. 4 is a flowchart depicting example operations 400 performed by one or more machines associated with a supplier of raw materials. In example embodiments, the operations 400 are performed by one or more of the supplier application(s) 102 of FIG. 1.

At operation 402, a sales order is generated in response to a purchase order being received (e.g., from one or more of the buyer application(s) 122 of FIG. 1).

At operation 404, a certificate of origin is obtained (e.g., from a CITES management authority). In example embodiments, the certificate of origin is obtained based on a determination that the sales order is for a specimen of CITES-protected wild flora or fauna. In example embodiments, the certificate of origin is obtained based on another requirement, such as a requirement of a purchaser or a regulatory body.

At operation 406, data pertaining to the certificate of origin is written as a block to a blockchain associated with the specimen. For example, data items pertaining to attributes and dimensions, geographical location, and validity period included in the certificate of origin may be written as a block (e.g., “Block A”) to the blockchain.

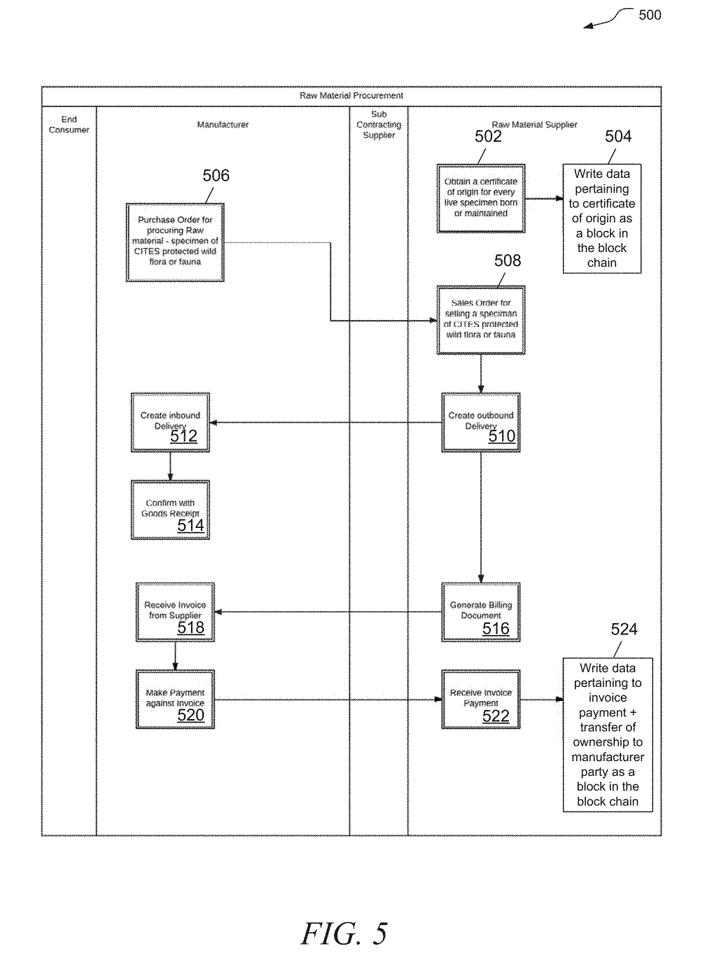

FIG. 5, is a flowchart depicting example operations 500) pertaining to a raw procurement process according to some example embodiments. In example embodiments, the operations 600 are performed by one or more supply chain (e.g., SaaS) applications executing on one or more machines of a raw material supplier, sub-contracting supplier, or manufacturer.

At operation 502, a raw material supplier obtains a certificate of origin for every live specimen bom or maintained.

At operation 504, the computer system(s) used by the raw material supplier writes data pertaining to the certificate of origin as a block in a blockchain (e.g., the consortium blockchain of FIG. 2).

At operation 506, a manufacturer generates a purchase order for producing a specimen of the raw material (e.g., of CITES-protected wild flora or fauna).

At operation 508, the raw material supplier generates a sales order for selling the specimen to the manufacturer.

At operation 510, the raw material supplier initiates an outbound delivery of the ordered specimen of raw material to the manufacturer.

At operation 512, the manufacturer initiates an inbound delivery of the specimen of the raw material from the raw material supplier.

At operation 514, the manufacturer generates a goods receipt to confirm the inbound delivery.

At operation 516, the raw material supplier generates a billing document pertaining to the sale of the specimen.

At operation 518, the manufacturer receives an invoice from the raw material supplier corresponding to the generated billing document.

At operation 520, the manufacturer initiates a payment pertaining to the invoice.

At operation 522, the raw material supplier receives the payment from the manufacturer.

At operation 524, the raw material supplier writes data pertaining to the invoice payment and transfer of ownership to the manufacturer as an additional block in the block chain.

As depicted in FIG. 5, one or more of the various operations discussed above may be handled by a subcontracting supplier on behalf of the supplier.

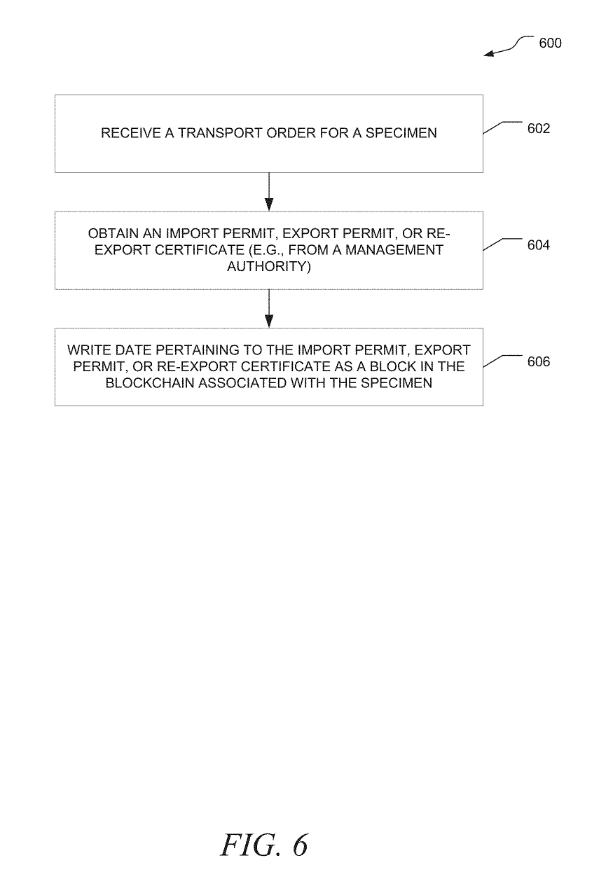

FIG. 6 is a flowchart depicting example operations 600 performed by one or more machines associated with a third party (e.g., a carrier agent) involved in a transaction (e.g., of the specimen of FIG. 4). In example embodiments, the operations 600 are performed by one or more supply chain (e.g., SaaS) applications executing on one or more machines of the third party.

At operation 602, a transport order for the specimen is received (e.g., from one or more of the supplier application(s) 102 of FIG. 1).

At operation 604, an import permit, export permit, or re-export certificate is obtained (e.g., from a State or CITES management authority). In example embodiments, the obtaining of the import permit, export permit, or re-export certificate is based on the rules set forth in CITES (e.g., with respect to whether the specimen is an Appendix-I, Appendix-II, or Appendix-III specimen), as described above.

At operation 606, data pertaining to the import permit, export permit, or re-export certificate written as a block to a blockchain associated with the specimen. For example, data items pertaining to a validity period, kinds of goods allowed, or volume of import included in the permit or certificate may be written as a block (e.g., “Block B”) to the blockchain.

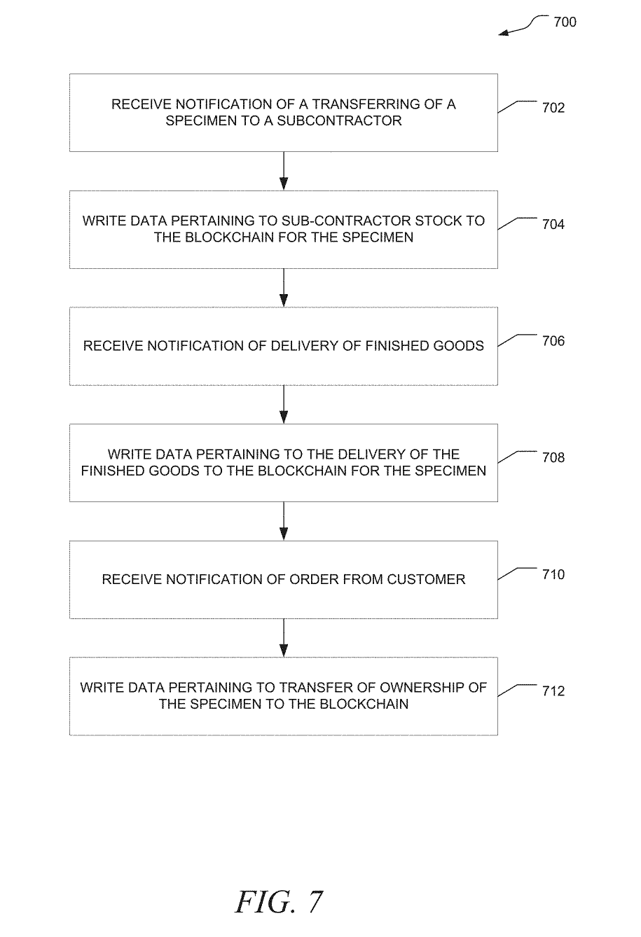

FIG. 7 is a flowchart depicting example operations 700 performed by one or more machines associated with a purchaser of the specimen of FIG. 4. In example embodiments, the operations 600 are performed by one or more of the buyer application(s) 122 of FIG. 1.

At operation 702, a notification that the specimen has been transferred to a subcontractor is received (e.g., from one or more supply chain applications executing on one or more machines of the subcontractor.

At operation 704, data pertaining to the transferring of the specimen to the subcontractor is written as a block (e.g., as Block C) to a blockchain associated with the specimen. For example, data included in a goods receipt is written to the blockchain.

At operation 706, a notification that finished goods have been received by the purchaser is received.

At operation 708, data pertaining to the receipt of the finished goods is written as a block (e.g., as Block D) to the blockchain associated with the specimen. For example, data included in a goods receipt of finished goods is written to the blockchain.

At operation 710, a notification of an order from a customer is received. Upon transfer of ownership to the customer, data pertaining to the transfer of ownership is written as a block (e.g., as Block E) to the blockchain. For example, an invoice or other evidence of transfer of ownership title is written to the block chain.

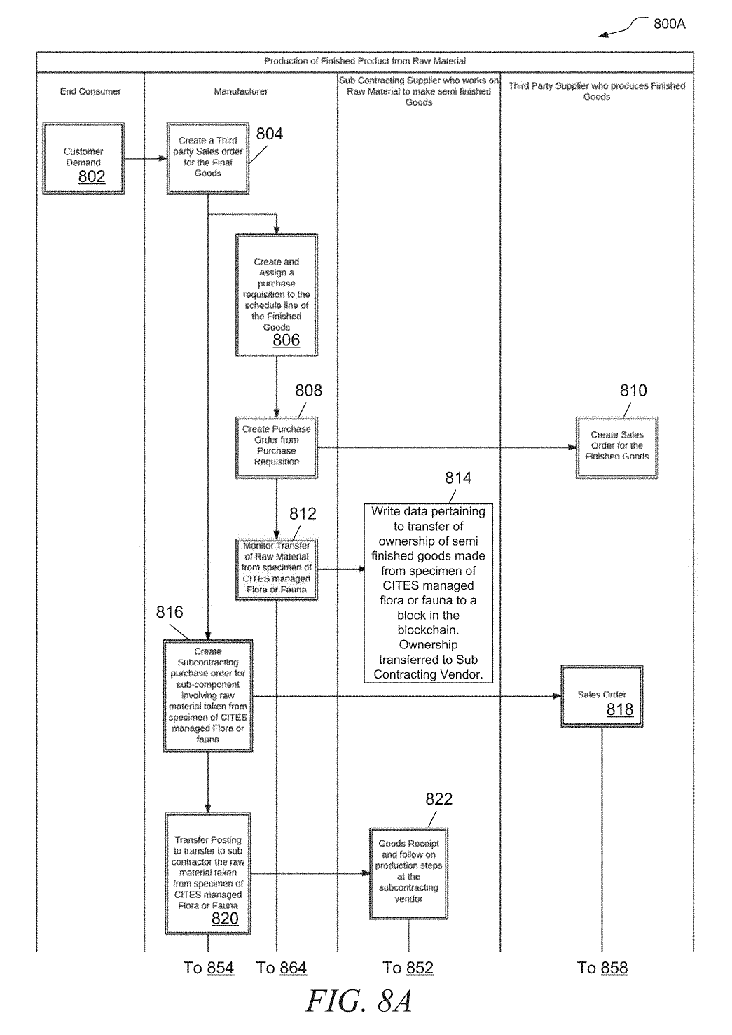

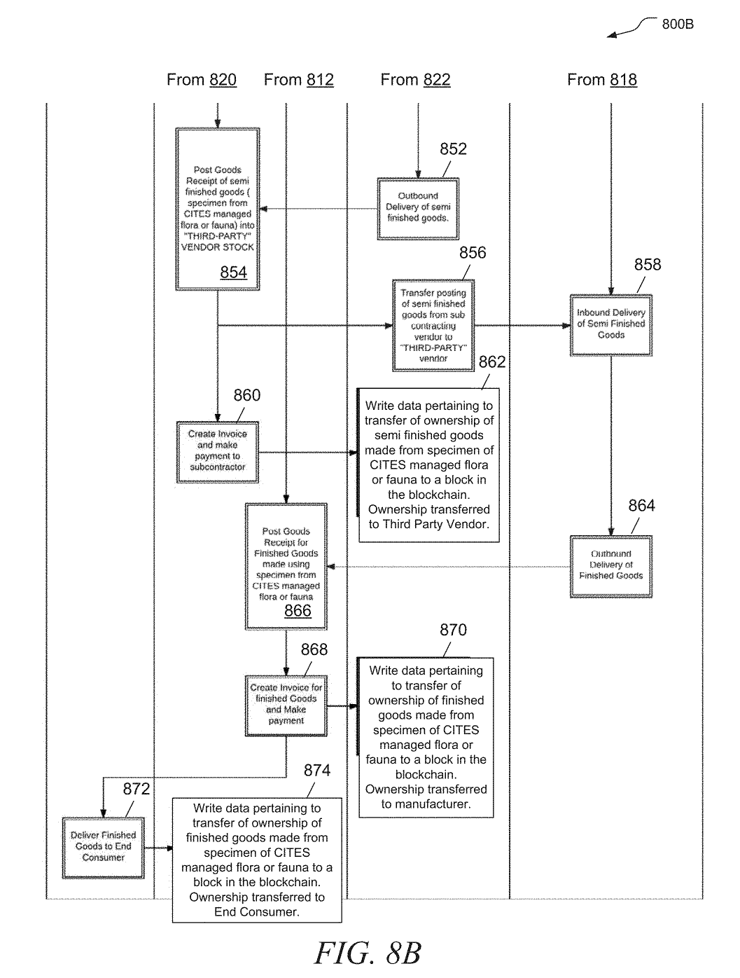

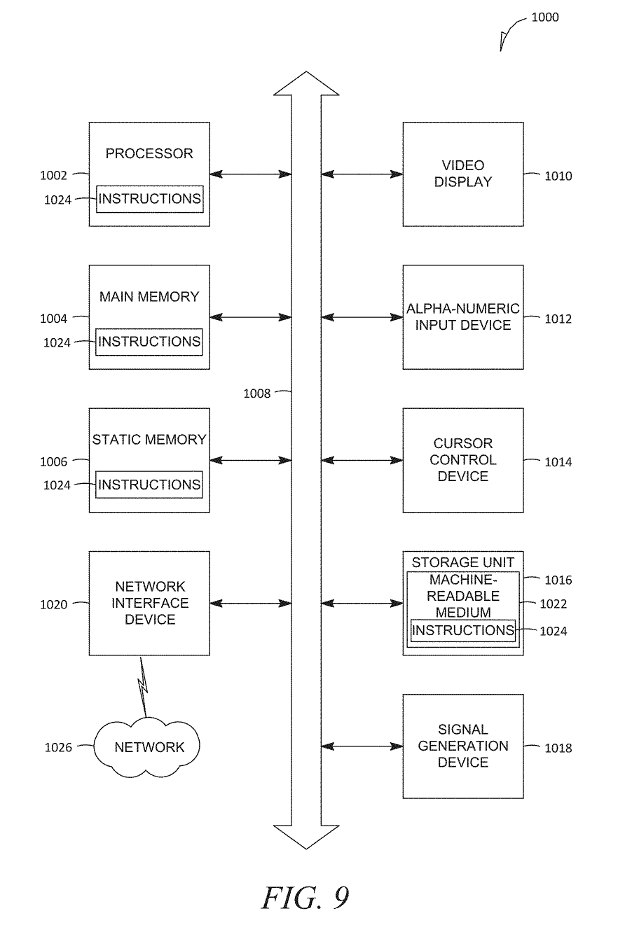

FIG. 8A and FIG. 8B are a flowchart depicting example operations 800A and 800B pertaining to production of a finished product from raw materials according to some example embodiments. In example embodiments, the operations 800A and 800B are performed by one or more supply chain (e.g., SaaS) applications executing on one or more machines of an end consumer, a manufacturer, a subcontracting supplier, or a third-party) supplier.

At operation 802, one or more end consumers generate demand for finished goods, such as by initiating a purchase of the finish goods via an electronic commerce web site.

At operation 804, the manufacturer creates a third-party sales order for the finished goods.

At operation 806, the manufacturer creates and assigns a purchase requisition to the schedule line of the finished goods.

At operation 808, the manufacturer creates a purchase order from the purchase requisition.

At operation 810, the third-party supplier creates a sales order fort the finished goods.

At operation 812, the manufacturer monitors transfers of specimens of raw materials (e.g., CITES-protected flora or fauna) that are used in the manufacturing of the finished goods.

At operation 814, the computer system(s) of the manufacturer write data pertaining to transfers of ownership of the semi-finished goods to a block in the blockchain (e.g., to reflect that ownership has been transferred to a sub-contracting vendor, who may work on the specimens of the raw material to make semi-finished goods).

At operation 816, the manufacturer creates a sub-contracting purchase order for a sub-component of the finished goods that involves the specimen of raw material.

At operation 818, the third-party supplier creates a sales order for the finished goods.

At operation 820, the manufacturer generates a transfer posting to reflect a transferring of the specimen to the sub-contractor.

At operation 822, the sub-contracting supplier generates a goods receipt and performs follow-on production steps.

At operation 852, the sub-contracting suppliers initiates outbound delivery of the semi-finished goods to the manufacturer.

At operation 854, the sub-contracting supplier posts a goods receipt corresponding to receipt of the semi-finished goods from a subcontracting vendor (e.g., into “third-party” vendor stock).

At operation 858, the third-party supplier initiates inbound delivery of the semi-finished goods from the sub-contracting supplier.

At operation 860, the manufacturer creates an invoice and makes payment to the sub-contracting supplier.

At operation 862, the computer system(s) of the manufacturer write data pertaining to transfer of ownership of the semi-finished goods as an additional block of the block chain, representing that ownership has been transferred to the third-party vendor.

At operation 864, the third-party supplier initiates outbound delivery of the finished goods.

At operation 866, the manufacturer posts a goods receipt for the finished goods.

At operation 868, the manufacturer creates an invoice for the finished goods and makes payment.

At operation 870, the computer system(s) of the manufacturer write data pertaining to transfer of ownership of the finished goods as an additional block of the block chain, representing that ownership has been transferred to the manufacturer.

At operation 872, the finished goods are delivered to the consumer.

At operation 874, the manufacturer writes data pertaining to transfer of ownership of the finished goods as an additional block in the block chain, representing that ownership has been transferred to an end consumer.

At operation 506, the sub-contracting supplier generates a transfer positing of semi-finished goods (e.g., to “third-party” vendor).

At any point during the operations described above with respect to FIGS. 1-8B (e.g., at any stage of the supply chain), any of a plurality of approved verifying authorities can access the blockchain (e.g., via one or more verification applications executing on one or more machines of the verifying authorities). For example, a verifying authority can access one or more particular blocks of the block chain to verify any of the data items included in the one or more particular blocks.

As an example, consider goods manufactured using skins of wild animals. These wild animals may be maintained by ranches or farms. For example, skins from crocodiles or alligators may come from crocodile or alligator ranches. These skins are required to carry tags, especially when in raw-material form or intermediate or finished goods are exported across international borders. Number of skins are confirmed with the CITES Secretariat and the required number of tags are ordered from a supplier and held by the local CITES management authority for attachment to each skim immediately before export. The skins are identified by a detailed field tag up to this point, for which the Management Authority applies a fee for each tag and export permit. Thus, appropriate data items pertaining to the tags may be required to be written to the blockchain at appropriate times in the supply chain. For example, custom extensions to the appropriate SaaS applications executing on one or more machines of particular entities are programmatically updated with any such rules to ensure compliance of the particular entities with all applicable regulations.

As another example, consider bobcat tags, which are required for any bobcat pelts that are sold, traded or shipped out of Texas. A pelt tag must be attached prior to being transported or shipped out of state. In addition, anyone who intends to transport or sell outside Texas the pelt of a bobcat taken in this state shall complete, sign, and submit an Out-of-State Shipping or Selling Report within 20 days of the time the pelt is shipped. Other CITES tags are required for all otters that are legally harvested in Texas. The pelts are required to be tagged with an otter CITES tag regardless of whether or not it is being shipped out of Texas. The otter pelt must be tagged within 90 days of take and is valid for the year in which the otter was taken. Thus, appropriate data items pertaining to local regulations and tagging may be required to be written to the blockchain at appropriate times in the supply chain. For example, custom extensions to the appropriate SaaS applications executing on one or more machines of particular entities are programmatically updated with any such rules to ensure compliance of the particular entities with all applicable regulations.

These methods and the example embodiments disclosed herein may be implemented by a specially-configured computer system. The computer system may be specially configured by one or more modules (e.g., hardware modules or software modules) and implemented by one or more computer processors of the computer system. These methods and the example embodiments disclosed herein may be embodied as instructions stored on a machine-readable medium that, when executed by one or more processors of a computer system, cause the computer system to perform one or more of the operations described herein.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In example embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 102) and via one or more appropriate interfaces (e.g., APIs).

Example embodiments may be implemented in digital electronic circuitry, or in computer hardware, firmware, or software, or in combinations of them. Example embodiments may be implemented using a computer program product (e.g., a computer program tangibly embodied in an information carrier, in a machine-readable medium for execution by, or to control the operation of, data processing apparatus, such as a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice.

FIG. 7 is a block diagram of machine in the example form of a computer system 1000 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a mobile phone (e.g., an iPhone or a mobile phone executing an Android operating system), a web appliance, a network router, a network switch or a network bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation (or cursor control) device 1014 (e.g., a mouse), a storage unit 1016 (e.g., a disk drive unit), a signal generation device 1018 (e.g., a speaker), and a network interface device 1020.

The storage unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 or within the processor 1002 during execution thereof by the computer system 1000, the main memory 1004 and the processor 1002 also constituting machine-readable media. The instructions 1024 may also reside, completely or at least partially, within the static memory 1006.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding, or carrying data structures utilized by or associated with such instructions. The term “machine-readable medium” shall accordingly be taken to include, but not be limited to, solid-state memories and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

Furthermore, the machine-readable medium is non-transitory in that it does not embody a propagating signal. However, labeling the tangible machine-readable medium as “non-transitorv” should not be construed to mean that the medium is incapable of movement—the medium should be considered as being transportable from one physical location to another. Additionally, since the machine-readable medium is tangible, the medium may be considered to be a machine-readable device.

The instructions 1024 may further be transmitted or received over a communications network 1026 using a transmission medium. The instructions 1024 may be transmitted using the network interface device 1020 and any one of a number of well-known transfer protocols (e.g., hypertext transfer protocol (HTTP)). Examples of communication networks include LANs, WANs, the Internet, mobile telephone networks, plain olde telephone service (POTS) networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1026 may be one of the networks 102.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of example embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of example embodiments. Combinations of the above embodiments, and other embodiments not specifically described herein, will be apparent to those of skill in the art upon reviewing the above description.

What is claimed is:

1. A system comprising:
a blockchain comprising a digital ledger that is distributed across a plurality of machines of a plurality of entities, the blockchain associated with a transaction of a specimen of at least one of wild flora and fauna, wherein:
a first group of the plurality of machines executing seller-side applications, the seller-side applications configuring one or more computer processors of the first group of the plurality of machines to perform seller-side blockchain operations, the seller-side blockchain operations comprising writing data items pertaining to origin and transfers of ownership as one or more blocks of a plurality of blocks of the blockchain:
a second group of the plurality of machines executing one or more buyer-side applications, the buyer-side applications configuring one or more computer processors of the second group of the plurality of machines to perform buyer-side blockchain operations, the buyer-side blockchain operations comprising writing data items pertaining to the transfers of ownership as one or more additional blocks of the plurality of blocks of the blockchain; and
a third group of the plurality of machines executing one or more verification applications, the verification applications configuring one or more computer processors of the third group of the plurality of machines to access one or more of the plurality of blocks of the blockchain to verify the one or more data items pertaining to the origin and transfers of ownership.

2. The system of claim 1, wherein a fourth group of the plurality of machines executes carrier-agent applications, the carrier-agent applications configuring one or more computer processors of the fourth group of the plurality of machines to perform carrier-agent blockchain operations, the carrier-agent blockchain operations comprising writing data items pertaining to at least one of an import permit, an export permit, a re-export certificate, tax payments, or movement of the specimen across international borders as a further block of the plurality of blocks of the blockchain.

3. The system of claim 1, wherein the transfer of ownership relates to delivery of raw materials to a subcontractor and the writing of the data items pertaining to the transfer of ownership includes writing data items pertaining to a goods receipt to one of the additional blocks of the plurality of blocks.

4. The system of claim 1, wherein the transfer of ownership relates to delivery of finished goods to a buyer and the writing of the data items pertaining to the transfer of ownership includes writing data items pertaining to a receipt of finished goods to one of the additional blocks of the plurality of blocks.

5. The system of claim 1, wherein the blockchain is a consortium blockchain corresponding to the plurality of entities and the plurality of entities includes at least two of a buyer, a seller, a subcontractor, a carrier agent, a customer, and a verifying authority.

6. The system of claim 1, wherein the transfer of ownership relates to delivery of finished goods to a customer of a buyer and the writing of the data items pertaining to the transfer of ownership includes writing data items pertaining to a transfer of ownership title to one of the additional blocks of the plurality of blocks.

7. The system of claim 6, wherein the data items pertaining to the transfer of ownership are derived from an invoice payment that is sent to one or more supply chain applications executing on one or more machines of the customer.

8. A method comprising:
distributing a plurality of blocks of a blockchain comprising a digital ledger across a plurality of machines of a plurality of entities, the blockchain associated with a transaction of a specimen of at least one of wild flora and fauna, wherein:
a first group of the plurality of machines executes seller-side applications, the seller-side applications configuring one or more computer processors of the first group of the plurality of machines to perform seller-side blockchain operations, the seller-side blockchain operations comprising writing data items pertaining to origin or transfers of ownership of the specimen as one or more blocks of the plurality of blocks of the blockchain,
a second group of the plurality of machines executes one or more buyer-side applications, the buyer-side applications configuring one or more computer processors of the second group of the plurality of machines to perform buyer-side blockchain operations, the buyer-side blockchain operations comprising writing data items pertaining to additional transfers of ownership as one or more additional blocks of the plurality of blocks of the blockchain; and
a third group of the plurality of machines executes one or more verification applications, the verification applications configuring one or more computer processors of the third group of the plurality of machines to access one or more of the plurality of blocks of the blockchain to verify authenticity of the specimen.

9. The method of claim 8, wherein a fourth group of the plurality of machines executes carrier-agent applications, the carrier-agent applications configuring one or more computer processors of the fourth group of the plurality of machines to perform carrier-agent blockchain operations, the carrier-agent blockchain operations comprising writing data items pertaining to at least one of an import permit, an export permit, a re-export certificate, tax payments, or movement of the specimen across international borders as a further block of the plurality of blocks of the blockchain.

10. The method of claim 8, wherein the transfer of ownership relates to delivery of raw materials to a subcontractor and the writing of the data items pertaining to the transfer of ownership includes writing data items pertaining to a goods receipt to one of the additional blocks of the plurality of blocks.

11. The method of claim 8, wherein the transfer of ownership relates to delivery of finished goods to a buyer and the writing of the data items pertaining to the transfer of ownership includes writing data items pertaining to a receipt of finished goods to one of the additional blocks of the plurality of blocks.

12. The method of claim 8, wherein the blockchain is a consortium blockchain corresponding to the plurality of entities and the plurality of entities includes at least two of a buyer, a seller, a subcontractor, a carrier agent, a customer, and a verifying authority.

13. The method of claim 8, wherein the transfer of ownership relates to delivery of finished goods to a customer of a buyer and the writing of the data items pertaining to the transfer of ownership includes writing data items pertaining to a transfer of ownership title to one of the additional blocks of the plurality of blocks.

14. The method of claim 8, wherein the data items pertaining to the transfer of ownership are derived from an invoice payment that is sent to one or more supply chain applications executing on one or more machines of the customer.

15. A non-transitory machine readable storage medium storing a set of instructions that, when executed by one or more processors of one or more machines associated with a plurality of entities, cause the one or more machines to perform operations, the operations comprising:
distributing a plurality of blocks of a blockchain comprising a digital ledger across the plurality of machines of the plurality of entities, the blockchain associated with a transaction of a specimen of at least one of wild flora and fauna, wherein:
a first group of the plurality of machines executes seller-side applications, the seller-side applications configuring one or more computer processors of the first group of the plurality of machines to perform seller-side blockchain operations, the seller-side blockchain operations comprising writing data items pertaining to a certificate of origin of the specimen in a block of a plurality of blocks of the blockchain;
a second group of the plurality of machines executes one or more buyer-side applications, the buyer-side applications configuring one or more computer processors of the second group of the plurality of machines to perform buyer-side blockchain operations, the buyer-side blockchain operations comprising writing data items pertaining to transfer of ownership in additional blocks of the plurality of blocks of the blockchain; and
a third group of the plurality of machines executes one or more verification applications, the verification applications configuring one or more computer processors of the third group of the plurality of machines to access one or more of the plurality of blocks of the blockchain to verify authenticity of the specimen.

16. The non-transitory machine readable storage medium of claim 15, wherein a fourth group of the plurality of machines executes carrier-agent applications, the carrier-agent applications configuring one or more computer processors of the fourth group of the plurality of machines to perform carrier-agent blockchain operations, the carrier-agent blockchain operations comprising writing data items pertaining to at least one of an import permit, an export permit, a re-export certificate, tax payments, or movement of the specimen across international borders as a further block of the plurality of blocks of the blockchain.

17. The non-transitory machine readable storage medium of claim 15, wherein the transfer of ownership relates to delivery of raw materials to a subcontractor and the writing of the data items pertaining to the transfer of ownership includes writing data items pertaining to a goods receipt to one of the additional blocks of the plurality of blocks.

18. The non-transitory machine readable storage medium of claim 15, wherein the transfer of ownership relates to delivery of finished goods to a buyer and the writing of the data items pertaining to the transfer of ownership includes writing data items pertaining to a receipt of finished goods to one of the additional blocks of the plurality of blocks.

19. The non-transitory machine readable storage medium of claim 15, wherein the blockchain is a consortium blockchain corresponding to the plurality of entities and the plurality of entities includes at least two of a buyer, a seller, a subcontractor, a carrier agent, a customer, and a verifying authority.

20. The non-transitory machine readable storage medium of claim 15, wherein the transfer of ownership relates to delivery of finished goods to a customer of a buyer and the writing of the data items pertaining to the transfer of ownership includes writing data items pertaining to a transfer of ownership title to one of the additional blocks of the plurality of blocks.
